(19) United States
(12) Patent Application Publication
(10) Pub. No.: US 2026/0061718 A1
(43) Pub. Date: Mar. 5, 2026

(54) HEATING TOOL AND HEAT-PRESSING MACHINE

(71) Applicant: Silhouette Japan Corporation, Kanagawa (JP)

(72) Inventor: Masaki SUGIYAMA, Kanagawa (JP)

(21) Appl. No.: 19/285,107

(22) Filed: Jul. 30, 2025

(30) Foreign Application Priority Data
Aug. 28, 2024 (JP) 2024-146677

(51) Int. Cl. B30B 15/34; B30B 1/04; B30B 15/06

(52) U.S. Cl. CPC B30B 15/34; B30B 1/04; B30B 15/064

(57) ABSTRACT

A heating tool heating object by pressing against its surface includes a housing, a cover which is provided at a tip of the housing and moves forward and backward relative to the housing to be switched between a normal position and a retracted position in which the cover is retracted from the normal position toward the housing, a biasing member that is attached to the cover and biases the cover toward the normal position, and a heating member that is attached inside the cover and is exposed from an opening at a tip of the cover in accordance with the forward and backward movement of the cover. The heating tool presses the tip of the cover against the surface of the heating object so that the cover is retracted to the retracted position and the heating member is in contact with the surface of the heating object through the opening.

This application claims priority from Japanese Patent Application Serial Number JP 2024-146677, filed Aug. 28, 2024, the entire contents of which are hereby incorporated by reference into this application.

### BACKGROUND OF THE INVENTION

### Field of the Invention

The present invention relates to a heating tool and a heat-pressing machine and particularly to a heating tool and a heat-pressing machine for heating a heating object while being pressed against a surface thereof.

### Description of the Related Art

Conventionally, there has been known a heat-pressing machine capable of performing a thermal transfer process by heating a thermal transfer sheet while being pressed against a transfer object such as clothing.

A thermal transfer sheet (iron print) is a sheet in which a heat-meltable adhesive (for example, a hot melt adhesive) is applied to a back side of a printed layer with a predetermined pattern or design. By melting the adhesive in a predetermined temperature environment and applying a predetermined pressure thereto, the adhesive permeates the transfer object, and thermal transfer sheet (printed layer) can be integrated with the transfer object.

Among the heat-pressing machines, there are some heat-pressing machines including a heating tool that is used as an auxiliary tool after a thermal transfer process by a heat-pressing body.

The heating tool is a tool used to eliminate minute uneven portions (bumps) by pressing a heating portion against the uneven portions if minute uneven portions (bumps) occur at the corners or edges when a thermal transfer sheet is attached to the transfer object.

For example, a heat-pressing machine described in JP 2021-31059 A includes a heating iron that is used after a thermal transfer process by a heat-pressing body and is capable of generating heat. The heating iron is stored in an iron storage portion of the heat-pressing body. Furthermore, a heat insulating member is provided inside the iron storage portion.

Further, although it is not used after a thermal transfer process by a heat-pressing machine (heat-pressing body), a portable hot stamp device such as that disclosed in JP H011-105492 A is also known.

Incidentally, since the heating tools described in JP 2021-31059 A and JP H011-105492 A include a heating portion (heating member) for heating a heating object while being pressed against a surface thereof, there is a possibility that a user may unintentionally touch the heating portion when the heating portion is exposed to the outside. Therefore, there is room for further improvement to enhance user convenience.

In addition, when the heating tool is used after the thermal transfer process by the heat-pressing machine (heat-pressing body), it is required to appropriately store the heating tool in the heat-pressing body. For example, it is required to store the heating tool without providing a heat insulating member in the heat-pressing body.

An object of the present invention is to provide a heating tool and a heat-pressing machine that are more convenient for users than ever before.

Further, another object of the present invention is to provide a heating tool and a heat-pressing machine that can be appropriately stored in a heat-pressing body.

### SUMMARY OF THE INVENTION

According to a heating tool of the present invention, the above-described problems are solved by a heating tool for heating a heating object while being pressed against a surface thereof, including: a housing which serves as a main body of the heating tool; a cover which is provided at a tip of the housing and moves forward and backward relative to the housing to be switched between a normal position and a retracted position in which the cover is retracted from the normal position toward the housing; a biasing member that is attached to the cover and biases the cover toward the normal position; and a heating member that is provided inside the cover and is exposed from an opening at a tip of the cover in accordance with the forward and backward movement of the cover, wherein the heating tool presses the tip of the cover against the surface of the heating object so that the cover is retracted to the retracted position and the heating member is brought into contact with the surface of the heating object through an opening of the cover.

With the above-described configuration, it is possible to realize the heating tool which is more convenient for the user.

Specifically, the heating tool includes the heating member that is attached inside the cover and is exposed from the opening at the tip of the cover in accordance with the forward and backward movement of the cover. Then, the tip of the cover is pressed against the surface of the heating object so that the cover is retracted to the retracted position and the heating member is brought into contact with the surface of the heating object through the opening of the cover.

Accordingly, the heating member can be stored inside the cover while the heating tool is not pressed against the surface of the heating object. Then, the heating member can be exposed by the contact with the surface of the heating object. Therefore, it is possible to prevent the user from unintentionally touching the heating member.

At this time, the cover may be a heat-resistant hollow cover, be provided to surround the heating member, and not be in contact with a portion that contacts the heating object in the heating member, and when the cover is retracted to the retracted position, the heating member may be formed so that a contact surface of the heating member is flush with a tip surface of the cover or be formed to protrude further than the tip of the cover.

With the above-described configuration, the heating member can be appropriately covered by the heat-resistant hollow cover. Then, the heating member can be exposed when the heating tool is pressed against the surface of the heating object.

At this time, the biasing member may connect the housing to the cover, be provided at a plurality of positions to sandwich the heating member therebetween, and bias the cover from the retracted position toward the normal position, and the cover may be disposed to be interposed between the heating member and the biasing member.

As described above, when the plurality of biasing members are provided, the cover can be more stably moved forward and backward.

Further, since the cover is disposed to be interposed between the heating member and the biasing member as described above, the heating member can be appropriately protected.

At this time, the cover may include a cover inner wall portion which extends in a forward and backward movement direction of the cover and is interposed between the heating member and the biasing member, a cover bottom wall portion which protrudes outward in a width direction of the heating tool from a tip of the cover inner wall portion and is disposed at a position facing a tip of the biasing member, and a cover outer wall portion which extends toward the opposite side to the biasing member in the forward and backward movement direction of the cover from an extension end of the cover bottom wall portion and is disposed to surround a tip of the heating member, and the tip of the biasing member may protrude toward the tip of the cover further than a base end of the heating member in the forward and backward movement direction of the cover and may not protrude further than the tip of the heating member.

With the above-described configuration, the cover, the heating member, and the biasing member can be compactly arranged. Further, the biasing member can bias the cover from the retracted position toward the normal position without interference between the biasing member and the heating member.

At this time, the heating tool may further include: a grip member that is fixed to the tip of the housing, is disposed to cover the cover from the outside, and is held by a user, the grip member may be disposed to surround the cover, the heating member, and the biasing member from the outside and be disposed at the same height position as the cover, the heating member, and the biasing member in a forward and backward movement direction of the cover, and an outer surface of the grip member may be provided with a plurality of protrusions which are arranged on the outer surface of the grip member at intervals and respectively extend in the forward and backward movement direction of the cover.

With the above-described configuration, the user can appropriately hold the heating tool by using the grip member. Further, since the grip member is disposed to cover the cover from the outside, it is possible to further prevent the user from unintentionally touching the heating member.

At this time, the heating tool may further include: a cable connection portion which is provided in the housing or a cap attached to a base end of the housing and is connected to an electric cable for supplying electricity; an operation switch which is provided in the housing or the cap and supplies electricity to the heating member or stops the supply of electricity; and a lamp which is provided in the housing or the cap and lights up when electricity is supplied to the heating member, the operation switch may be disposed on the opposite side to the cable connection portion in an outer peripheral surface or an outer surface of the heating tool, and the lamp may be disposed on the opposite side to the cable connection portion and on the side of the operation switch in the outer peripheral surface or the outer surface of the heating tool.

With the above-described configuration, the operation switch can be disposed at a position in which the operation switch is easily operated by the user, and the lamp can be disposed at a position in which the lamp is easily and visually checked by the user.

Further, according to a heat-pressing machine of the present invention, the above-described problems are solved by a heat-pressing machine with the heating tool, including: a heat-pressing body which serves as a main body of the heat-pressing machine, wherein the heating tool is used after a thermal transfer process by the heat-pressing body, wherein a bottom surface of the heat-pressing body is provided with a storage recess for storing the heating tool, wherein the heating tool is storable in the storage recess in a state of the normal position in which the heating member is stored inside the heating tool and is removable from the storage recess in the state of the normal position, and wherein the heating tool is stored in the storage recess not to protrude from the storage recess.

With the above-described configuration, it is possible to realize the heat-pressing machine in which the heating tool can be appropriately stored in the heat-pressing body.

Particularly, since the heating tool is stored in the storage recess in the state of the “normal position” in which the heating member is stored inside the heating tool, a heat insulating member may not be provided in the storage recess.

According to the heating tool and the heat-pressing machine of the present invention, the convenience of the user can be greater than ever before.

Further, the heating tool can be appropriately stored in the heat-pressing body.

### BRIEF DESCRIPTION OF THE DRAWINGS

FIG. 1 is a perspective view of a heat-pressing machine and is a diagram showing a state at a “normal position”.

FIG. 2 is a perspective view of a heat-pressing machine and is a diagram showing a state at a “press position”.

FIG. 3 is a bottom view of a heat-pressing machine and is a diagram showing a state in which a heating tool is stored.

FIG. 4 is a perspective view of a heating tool.

FIG. 5 is a cross-sectional view of a heating tool.

FIG. 6 is a diagram showing a state before a heating tool is pressed against a surface of a heating object (a transfer object, a thermal transfer sheet).

FIG. 7 is a diagram showing a state in which a cover of a heating tool comes into contact with a surface of a heating object.

FIG. 8 is a diagram showing a state in which a cover of a heating tool is pressed against a surface of a heating object.

### DESCRIPTION OF THE PREFERRED EMBODIMENTS

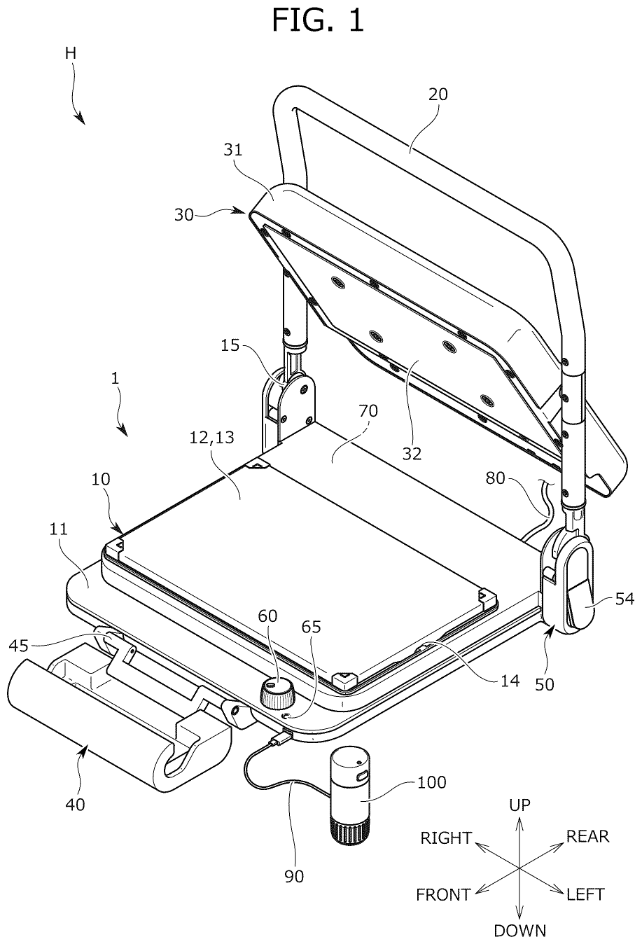

Hereinafter, embodiments of the present invention will be described with reference FIGS. 1 to 8.

This embodiment relates to a “heating tool” which is used when heating a heating object while being pressed against a surface thereof and has greater convenience for a user than ever before.

Further, this embodiment relates to a “heat-pressing machine” which is able to appropriately store a heating tool.

### Entire Configuration

A heat-pressing machine H is, as shown in FIGS. 1 to 4, a portable and compact heat-pressing machine, and receives a user's operation input and performs desired thermal transfer by heating a thermal transfer sheet while being pressed against a transfer object in a preset temperature environment.

The heat-pressing machine H includes a heat-pressing body 1 which is a main body of the heat-pressing machine H and a heating tool 100 which is used after a thermal transfer process using the heat-pressing body 1 to perform desired thermal transfer.

Furthermore, the heat-pressing machine H may be a large heat-pressing machine.

The “transfer object” is a base material onto which a thermal transfer sheet is transferred, and specifically includes textile products such as clothing. Furthermore, the present invention is not particularly limited to textile products, and can be applied to a wide range of base materials that can be thermally transferred.

The “thermal transfer sheet” is a sheet in which a heat-meltable adhesive layer is formed on a back side of a printed layer. Specifically, the sheet is cut into a desired shape using a cutting plotter or the like before thermal transfer process. Furthermore, the sheet is not particularly limited as long as thermal transfer can be performed.

### Heat-Pressing Body

The heat-pressing body 1 includes, as shown in FIGS. 1 to 3, a base member 10 on which the transfer object and thermal transfer sheet are placed, a rotating member 20 that is attached to the base member 10 via a rotating shaft 15, and a pressing member 30 that is attached to the rotating member 20, disposed to sandwich the transfer object and thermal transfer sheet between the pressing member and the base member 10, and adapted to rotate together with the rotating member 20 to press the base member.

Further, the heat-pressing body 1 includes a handle 40 which is attached to the front end of the base member 10 via a handle shaft 45 and a locking device 50 which is attached to the rear end of the base member 10 and locks the rotating operation of the rotating member 20 relative to the base member 10.

Further, the heat-pressing body 1 includes a user operation unit 60 which receives a user's operation input, a lamp 65 which lights up when electricity is supplied to the heat-pressing body 1, and a controller 70 which is provided inside the heat-pressing body 1 and performs various calculations and controls.

In addition, a cord connection portion for connecting a power cord 80 is provided at the rear end of the base member 10, and a cable connection portion for connecting an electric cable 90 is provided at the front end of the base member 10.

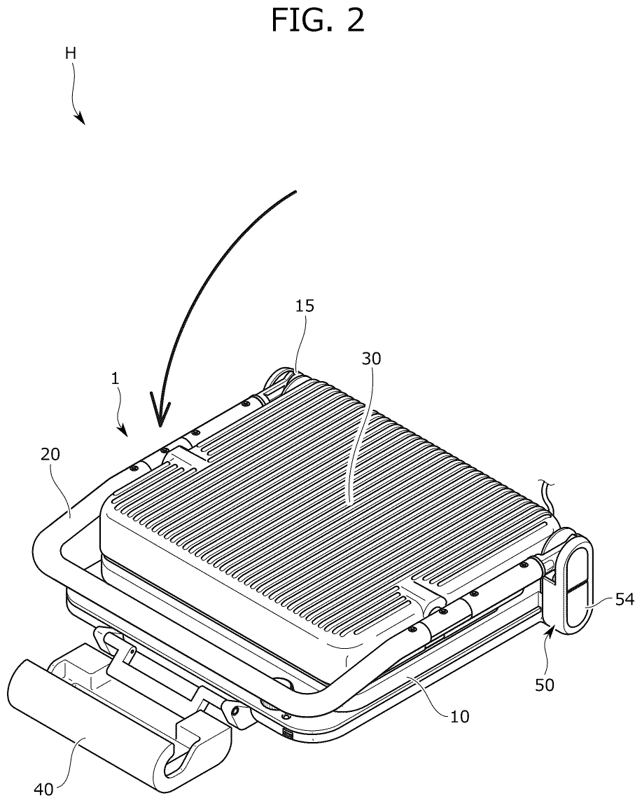

The base member 10 is, as shown in FIGS. 1 and 2, a member that serves as a placement table (press table) of the heat-pressing body 1, and includes a base body 11 which serves as a main body of the base member 10, a placement plate 12 which is attached to the upper surface of the base body 11 to place the transfer object and thermal transfer sheet thereon, and a heat-resistant placement mat 13 which is attached to the surface of the placement plate 12.

The placement plate 12 is adapted to be swingable (to sway) relative to the base body 11 around a support shaft 14.

The rotating member 20 is a rotating frame which rotates around the rotating shaft 15 relative to the base member 10.

Specifically, the rotating member 20 rotates to be switched between a “normal position” in which the rotating member stands upward relative to the base member 10 and a “press position” in which the pressing member 30 is in contact with the base member 10.

For example, the user can rotate the rotating member 20 by holding the rotating member 20 with one hand (left hand) and operating the operation member 54 of the locking device 50 with the other hand (right hand).

The pressing member 30 is a member that serves as a heat-pressing plate of the heat-pressing body 1, disposed inside the frame-shaped rotating member 20, and adapted to rotate together with the rotating member 20.

The pressing member 30 includes a pressing body 31 which is swingably attached to the rotating member 20 and a heater unit 32 which is provided on the back surface of the pressing body 31 and is able to generate heat.

When the rotating member 20 rotates relative to the base member 10, the pressing member 30 presses the base member 10 while the heater unit 32 faces the placement plate 12. Then, the placement plate 12 and the pressing body 31 respectively swing so that the placement surface of the placement plate 12 and the heater surface of the heater unit 32 are aligned.

Accordingly, the heat-pressing body 1 can perform a heat-pressing operation with a more uniform pressure.

The handle 40 is a portion that the user holds when carrying the heat-pressing machine H, and is attached to the front end of the base member 10.

The handle 40 is rotatably attached to the base member 10 via the handle shaft 45, and also has a function of being hooked to the rotating member 20 when the heat-pressing body 1 is folded (the heat-pressing body 1 is located at the “press position”).

The locking device 50 is, as shown in FIGS. 1 and 2, a device that locks the rotating operation of the rotating member 20 relative to the base member 10 and connects the rear end of the base member 10 to the lower end of the rotating member 20.

The locking device 50 can lock the rotating member 20 when the rotating member 20 is located at the “normal position”.

The user operation unit 60 is for receiving a user's operation input for operating thermal transfer process and is attached to the upper surface of the base member 10.

The user operation unit 60 is, for example, an operation dial and can set the heating temperature of the heater unit 32.

The lamp 65 is an LED lamp that lights up when the heater unit 32 is generating heat, and notifies the user that the heater unit 32 is generating heat.

The controller 70 includes a CPU (processor) as a data arithmetic/control processing device, a ROM and a RAM as storage devices, and a communication interface for transmitting and receiving information data.

The controller 70 is configured to perform a thermal transfer process at a preset heating temperature and for a preset heating time by receiving a signal from the user operation unit 60 and transmitting a control signal to the heater unit 32.

In the above-described configuration, the heat-pressing body 1 is connected to an external power source via the power cord 80, and the AC power supplied from the power source is rectified by a rectifier circuit and then supplied to each component such as the heater unit 32.

### Heating Tool

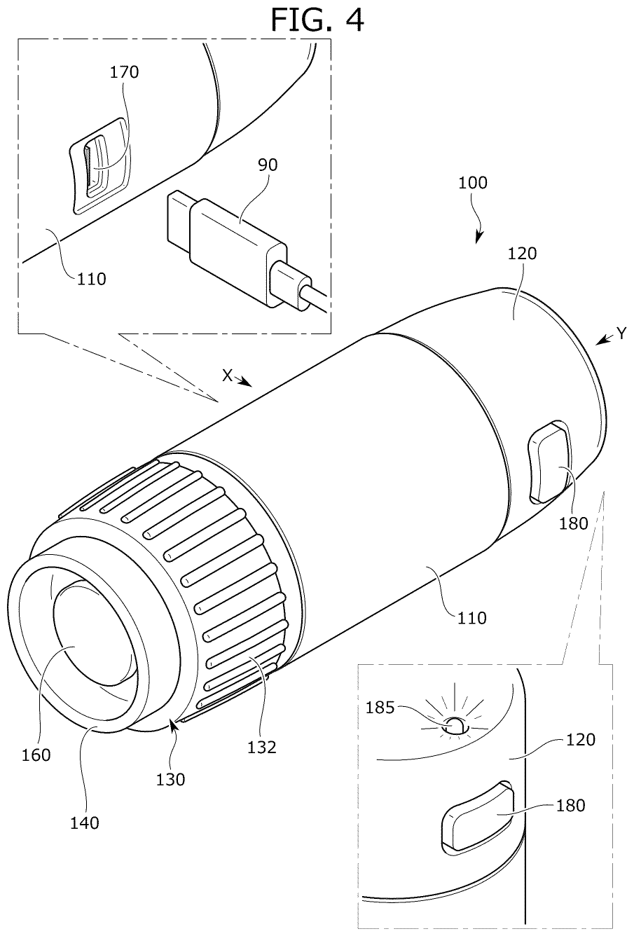

The heating tool 100 is, as shown in FIGS. 4 to 8, a tool that heats the heating object while being pressed against the surface of the heating object, and is used as an auxiliary tool after the heat-pressing body 1 performs a thermal transfer process.

Specifically, if minute uneven portions (bumps) appear at the corners or edges of the transfer object when a thermal transfer sheet S is attached to the transfer object M, the heating tool 100 can be heat-pressed against minute uneven surfaces for repair.

The heating tool 100 is a stamp type heating tool having a heating member 160, and is also called a mini iron.

The heating tool 100 is adapted to be switched between a “normal position” in which the heating member 160 is stored inside the heating tool and a “retracted position” in which the heating member 160 is exposed to the outside.

Furthermore, the heating tool 100 is formed to have a circular cross-section, but may also be formed to have a rectangular cross-section (high cross-section).

Specifically, the heating tool 100 includes a hollow housing 110, a cap 120 which is attached to the base end of the housing 110, a grip member 130 that is fixed to the tip of the housing 110 and is held by the user, a cover 140 which is provided at the tip of the housing 110 and moves forward and backward relative to the housing 110, a biasing spring 150 which is attached inside the cover 140 and biases the cover 140 to a predetermined position, and the heating member 160 which is exposed from the opening at the tip of the cover 140 in accordance with the forward and backward movement of the cover 140.

The cover 140 moves toward and away from the housing 110, and is switched between the “normal position” and the “retracted position” retraced from the normal position toward the housing 110.

The biasing spring 150 is a biasing member (pressing spring) that biases the cover 140 from the retracted position toward the normal position.

In addition, the heating tool 100 includes a cable connection portion 170 which is connected to the electric cable 90 for supplying electricity, an operation switch 180 which supplies electricity to the heating member 160 or stops the supply of electricity, and a lamp 185 which lights up when electricity is supplied to the heating member 160.

In the above-described configuration, in the heating tool 100, the cover 140 can be retracted to the “retracted position (use position)” by pressing the tip of the cover 140 against the surface of the heating object, and the heating member 160 can be exposed through the opening of the cover 140 so that the heating member 160 comes into contact with the surface of the heating object. Accordingly, the heating tool 100 can heat the heating object.

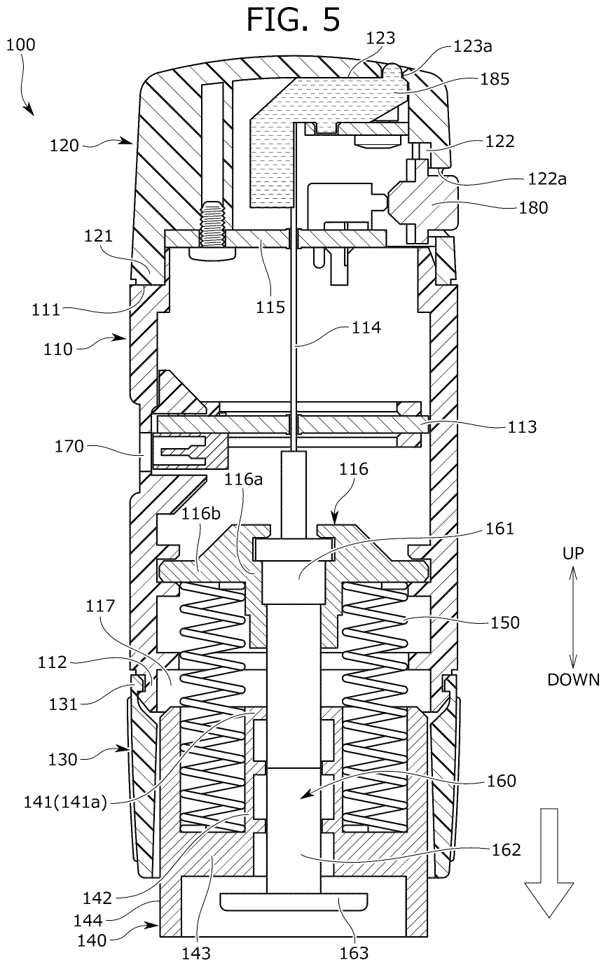

As shown in FIGS. 4 and 5, the housing 110 is a cylindrical case that serves as the main body of the heating tool 100, and is made of a heat-resistant resin.

The housing 110 includes a cap fitting portion 111 which is formed at the base end (upper end) thereof for fitting the cap 120 and a grip hook portion 112 which is formed at the tip (lower end) of the housing 110 for hooking the grip member.

A cable connection portion 170 (cable connection hole) is formed on the outer peripheral surface of the housing 110.

A substrate 113 which is connected to the cable connection portion 170, a metal rod 114 which is connected to the substrate and extends in the extending direction of the housing 110, and a second substrate 115 which is connected to the upper end of the metal rod 114 are stored in a fixed state inside the housing 110.

The heating member 160 is connected to the lower end of the metal rod 114. The operation switch 180 and the lamp 185 are connected to the upper end of the metal rod 114 or the second substrate 115.

Further, a holding member 116 is fixed to the lower end side position of the cable connection portion 170 inside the housing 110.

The holding member 116 is a member that holds the biasing spring 150 and the heating member 160, and includes a hollow main body portion 116a and a flange portion 116b which protrudes outward from the outer peripheral surface of the main body portion 116a.

The main body portion 116a holds the base end of the heating member 160, and the metal rod 114 and the heating member 160 (shaft portion 161) are inserted into the hollow portion of the main body portion 116a.

Furthermore, the metal rod 114 and the heating member 160 may be inserted from the upper end of the holding member 116 to penetrate the holding member.

The flange portion 116b holds the base ends of the plurality of biasing springs 150. Specifically, the holding member 116 is fixed to the housing 110 and is in a contact state so that the flange portion 116b presses the biasing spring 150 toward the tip side of the housing 110.

As shown in FIGS. 4 and 5, the cap 120 is a member that covers the upper end of the housing 110, and is made of a heat-resistant resin.

The cap 120 includes a housing fitting portion 121 which is fitted to the housing 110 (cap fitting portion 111), a switch attachment portion 122 which is formed on the outer peripheral surface of the cap 120 to attach the operation switch 180 thereto, and a lamp attachment portion 123 which is formed on the upper surface of the cap 120 to attach the lamp 185 thereto.

The operation switch 180 and the lamp 185 are stored inside the cap 120. A part of the operation switch 180 is exposed through an opening 122a of the cap 120, and a part of the lamp 185 is exposed through an opening 123a.

The grip member 130 is a cylindrical member that is held by the user, and is fixed to the tip of the housing 110 to cover the cover 140 from the outside.

The grip member 130 is disposed to surround the cover 140, the biasing spring 150, and the heating member 160 from the outside, and is disposed at the same height position as the cover 140, the biasing spring 150, and the heating member 160 in the longitudinal direction of the housing 110.

Furthermore, the “same height position” does not necessarily mean that the two are exactly at the same height position, but rather that at least a part of each of them is disposed at the same height position.

The grip member 130 includes a housing hook portion 131 which is hooked to the housing 110 (grip hook portion 112).

Further, a plurality of protrusions 132 are formed on the outer peripheral surface of the grip member 130 to be arranged at intervals along the outer peripheral surface and extend in the longitudinal direction of the housing 110.

With the above-described configuration, the user can appropriately hold the heating tool 100 using the grip member 130.

As shown in FIGS. 4 and 5, the cover 140 is a cover that covers the heating member 160, and is made of a heat-resistant resin.

The cover 140 is attached to the tip of the housing 110, and is switchable between a “normal position” in which the heating member 160 is stored inside the cover and a “retracted position” in which the cover is retracted from the normal position toward the housing 110.

The cover 140 is provided to surround the heating member 160, and is formed not to contact a portion (second heating portion 163) that contacts the heating object in the heating member 160.

Furthermore, a predetermined gap 117 (space) is formed between the housing 110 and the cover 140 in the forward and backward movement direction of the cover 140. Therefore, the cover 140 is movable forward and backward relative to the housing 110.

The cover 140 includes a cover upper wall portion 141, a cover inner wall portion 142 which extends in the forward and backward movement direction of the cover 140 and is interposed between the heating member 160 and the biasing spring 150, a cover bottom wall portion 143 which extends from the tip of the cover inner wall portion 142 outward in the left and right direction of the heating tool 100 and faces the tip of the biasing spring 150, and a cover outer wall portion 144 which extends from the extension end of the cover bottom wall portion 143 in the forward and backward movement direction of the cover and surrounds the tip of the heating member 160.

The cover upper wall portion 141 is provided with a through-hole 141a, and the heating member 160 (shaft portion 161) passes through the through-hole 141a.

The cover inner wall portion 142 supports the heating member 160 (shaft portion 161, first heating portion 162) in a surrounding manner.

The cover bottom wall portion 143 is connected to the tip of the biasing spring 150, and is disposed to sandwich the biasing spring 150 between the holding member 116 and the cover bottom wall portion in the forward and backward movement direction of the cover 140.

The cover outer wall portion 144 extends longitudinally in the direction in which the cover 140 moves forward and backward.

The cover outer wall portion 144 is disposed to sandwich the biasing spring 150 between the cover inner wall portion 142 and the cover outer wall portion in the width direction of the heating tool 100.

The cover outer wall portion 144 is disposed to surround the heating member 160 (second heating portion 163).

The biasing spring 150 is a biasing member that connects the housing 110 (holding member 116) to the cover 140 and biases the cover 140 from the retracted position toward the normal position.

The biasing spring 150 is, for example, a pressing spring (compression spring) and is disposed at a plurality of positions inside the housing 110 to surround the heating member 160.

In this embodiment, two biasing springs 150 are arranged.

As shown in FIG. 5, the tip of the biasing spring 150 protrudes toward the tip of the cover 140 further than the base end (shaft portion 161) of the heating member 160 in the forward and backward movement direction of the cover 140.

Further, the tip of the biasing spring 150 does not protrude toward the tip of the cover 140 further than the tip (second heating portion 163) of the heating member 160.

With the above-described configuration, the cover 140, the biasing spring 150, and the heating member 160 can be compactly arranged.

The heating member 160 is a member that heats a heating object, and is made of a metal having high thermal conductivity.

The heating member 160 is attached inside the cover 140 and is exposed from the opening at the tip of the cover 140 in accordance with the forward and backward movement of the cover 140.

The heating member 160 includes the cylindrical shaft portion 161 which is held by the holding member 116 of the housing 110 and extends toward the tip of the housing 110, the rod-shaped or cylindrical first heating portion 162 which is attached to the tip of the shaft portion 161 and extends toward the tip of the cover 140, and the disk-shaped second heating portion 163 which is continuously provided at the tip of the first heating portion 162.

The shaft portion 161 is made of a heat-resistant resin or metal.

The first heating portion 162 and the second heating portion 163 are made of a metal having high thermal conductivity.

The shaft portion 161 is held by the holding member 116 and is supported to be movable inside the cover 140 (cover inner wall portion 142).

The first heating portion 162 and the second heating portion 163 are connected to the cable connection portion 170 via the substrate 113 and the metal rod 114. Heat is generated at a predetermined heating temperature by receiving electricity via the cable connection portion 170.

The first heating portion 162 and the second heating portion 163 are supported to be movable inside the cover 140.

The cable connection portion 170 is formed on the outer peripheral surface of the housing 110 to connect the electric cable 90.

The cable connection portion 170 is electrically connected to the heating member 160 and the lamp 185 via the substrate 113, the metal rod 114, and the second substrate 115.

Furthermore, the cable connection portion 170 may be formed on the outer peripheral surface of the cap 120.

The operation switch 180 is a switch which is provided on the outer peripheral surface of the cap 120 and supplies electricity to the heating member 160 or stops the supply of electricity thereto.

Furthermore, the operation switch 180 may be formed on the outer peripheral surface of the housing 110.

Specifically, when the operation switch 180 is pushed by the user to be switched from “off” to “on”, the substrate 113, the metal rod 114, and the second substrate 115 are switched from a “non-connection state” to a “connection state”. For example, the operation switch 180 moves the substrate 113 and the metal rod 114 to contact each other. In this way, electricity is supplied to the heating member 160.

Further, when the operation switch 180 is switched again from “on” to “off” by the user's push operation, the substrate 113, the metal rod 114, and the second substrate 115 are switched from a “connection state” to a “non-connection state”. For example, the operation switch 180 moves the substrate 113 and the metal rod 114 to be separated from each other. In this way, the supply of electricity to the heating member 160 is stopped.

The lamp 185 is an LED lamp which is provided on the upper surface of the cap 120 and lights up when the heating member 160 is generating heat.

The lamp 185 notifies that the heating member 160 is generating heat. Furthermore, the lamp 185 may be formed on the outer peripheral surface of the housing 110.

In the above-described configuration, the operation switch 180 is disposed on the opposite side to the cable connection portion 170 in the outer peripheral surface of the heating tool 100.

Further, the lamp 185 is disposed on the opposite side to the cable connection portion 170 in the outer peripheral surface of the heating tool 100 and is disposed on the side of the operation switch 180.

Accordingly, the operation switch 180 can be disposed at a position in which the operation switch is easily operated by the user, and the lamp 185 can be disposed at a position in which the lamp is easily and visually checked by the user.

### Heating by Heating Tool

The heating tool 100 can heat the heating object by pressing the tip of the cover 140 against the surface of the heating object, moving the cover 140 from the “normal position” to the “retracted position”, and brining the heating member 160 into contact with the surface of the heating object.

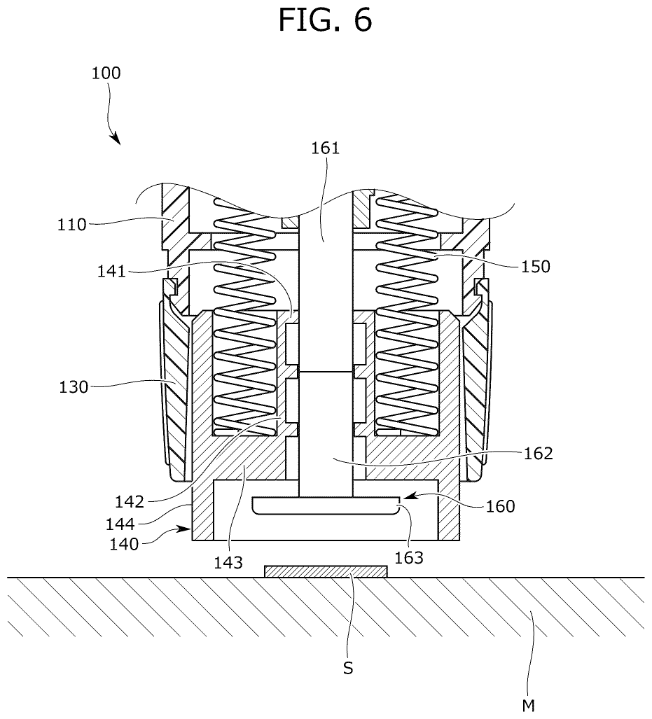

Hereinafter, a detailed description will be made with reference to FIGS. 6 to 8.

FIG. 6 is a diagram showing a state before the heating tool 100 is pressed against the surface of the heating object (the transfer object M, the thermal transfer sheet S).

At this time, the cover 140 is pushed out by the biasing force of the biasing spring 150 to be biased toward the “normal position”.

Since the cover 140 is located at the “normal position”, the heating member 160 is stored inside the cover 140 and is completely covered by the cover 140.

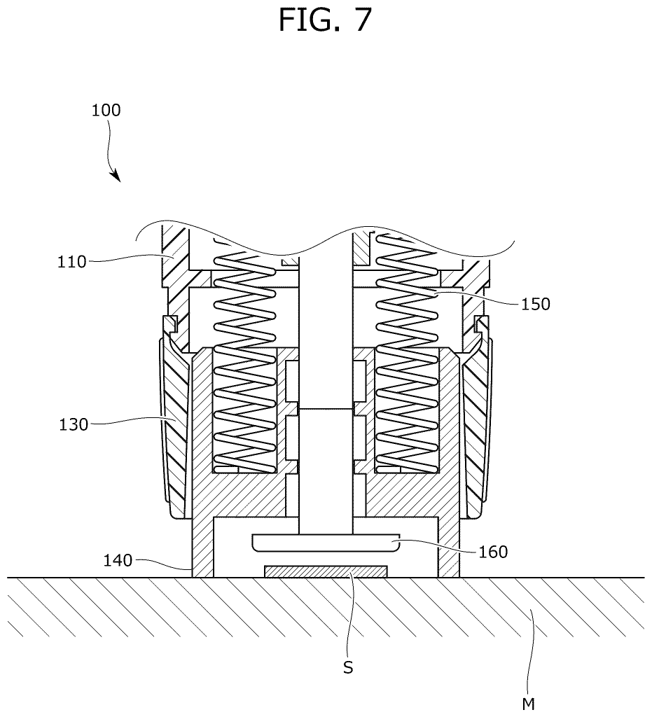

FIG. 7 is a diagram showing a state in which the cover 140 of the heating tool 100 is in contact with the surface of the heating object.

Specifically, the cover 140 is located at the “normal position”, and the heating member 160 is stored inside the cover 140. Therefore, the cover 140 first comes into contact with the surface of the heating object.

That is, the heating member 160 is not in contact with the surface of the heating object.

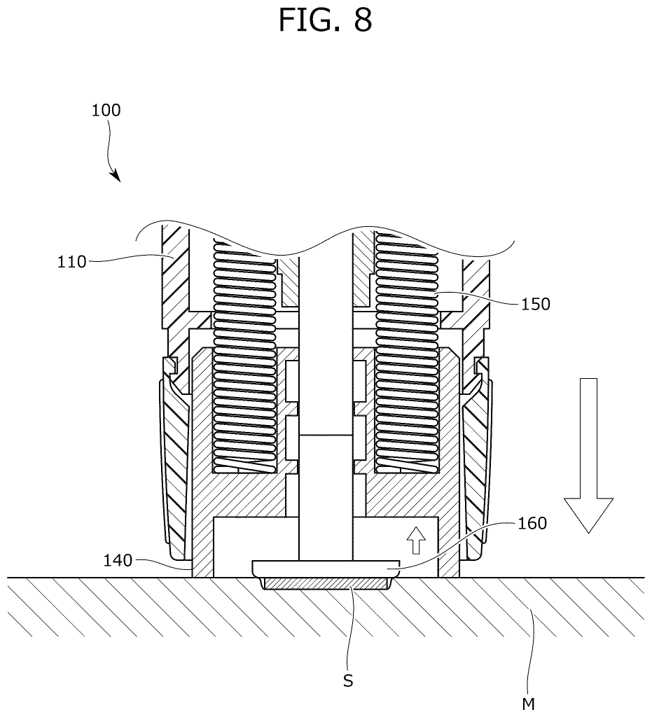

FIG. 8 is a diagram showing a state in which the heating member 160 of the heating tool 100 is pressed against the surface of the heating object.

Specifically, the cover 140 is pressed against the surface of the heating object so that the cover 140 moves from the “normal position” to the “retracted position” against the biasing force of the biasing spring 150.

Accordingly, the heating member 160 is exposed from the opening at the tip of the cover 140 and comes into contact with the surface of the heating object. Then, the heating member 160 can heat the surface of the heating object. That is, the heating tool 100 can perform the finishing of the thermal transfer process.

In the above-described configuration, as shown in FIG. 8, when the cover 140 is retracted to the “retracted position”, the heating member 160 is formed so that the contact surface of the heating member 160 is flush (substantially flush) with the tip surface of the cover 140.

Therefore, the heating member 160 can be appropriately brought into contact with the surface of the heating object.

Furthermore, the heating member 160 may be formed to protrude further than the tip of the cover 140.

In the above-described configuration, although it is stated that the heating member 160 is exposed from the tip of the cover 140, this includes a state in which the contact surface of the heating member 160 is flush with the tip surface of the cover 140. That is, when the heating member 160 can come into contact with the surface of the heating object, the heating member 160 is exposed from the cover 140.

Furthermore, if the heating member 160 slightly protrudes from the cover 140, the heating member 160 is also exposed from the cover 140.

### Storage of Heating Tool

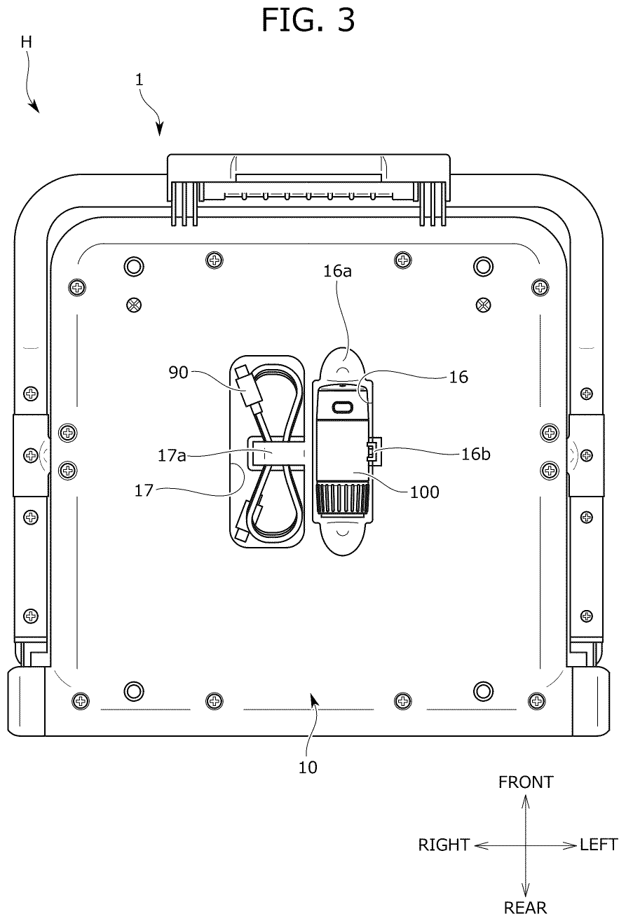

As shown in FIG. 3, the bottom surface of the heat-pressing body 1 is provided with a storage recess 16 (storage portion) which stores the heating tool 100 and a removal recess 16a which is formed on the outer edge of the storage recess 16 to remove the heating tool 100.

Further, a hook portion 16b for hooking the heating tool 100 in a stored state is formed on the outer edge of the storage recess 16.

The heating tool 100 is storable in the storage recess 16 in the state of the “normal position” in which the heating member 160 is stored inside the heating tool and is removable from the storage recess 16 in the state of the “normal position”.

Specifically, the heating tool 100 is stored in the storage recess 16 not to protrude outward from the storage recess 16.

A cable storage recess 17 for storing the electric cable 90 is formed at a position adjacent to the storage recess 16 in the bottom surface of the heat-pressing body 1. A hook portion 17a for hooking the electric cable 90 in a stored state is formed on the outer edge of the cable storage recess 17.

In the above-described configuration, as shown in FIG. 1, the heating tool 100 is connected to the heat-pressing body 1 (cable connection portion) via the electric cable 90, and can receive electricity via the heat-pressing body 1.

Then, the heating tool 100 can heat the heating object by generating heat from the heating member 160 while being connected to the heat-pressing body 1.

Furthermore, the heating tool 100 may be provided with a separate battery. Then, the heating member 160 can generate heat even when not connected to the heat-pressing body 1.

The heating tool 100 can provide greater convenience to the user than ever before. Specifically, the heating member 160 can be stored inside the cover 140 while the heating tool 100 cannot be pressed against the surface of the heating object. Then, the heating member 160 can be exposed by pressing the heating tool 100 against the surface of the heating object. Accordingly, it is possible to prevent the user from unintentionally touching the heating member 160.

Further, in the case of the heat-pressing machine H, the heating tool 100 can be appropriately stored in the heat-pressing body 1.

Particularly, the heating tool 100 is stored in the storage recess 16 in the state of the “normal position” in which the heating member 160 is stored inside the heating tool. Therefore, a separate heat insulating member may not be provided in the storage recess 16, and the heating tool 100 can be stored with a simple structure.

### Others

In the above-described embodiment, as shown in FIG. 1, the heating tool 100 is used as an auxiliary tool after thermal transfer process by the heat-pressing body 1, but this is not particularly limited.

For example, the heating tool 100 may be pressed against the surface of the heating object by the purpose other than thermal transfer process to heat the heating object.

In the above-described embodiment, as shown in FIG. 5, the biasing spring 150 (pressing spring) biases the cover 140 from the “retracted position” toward the “normal position”, but this is not particularly limited.

For example, the biasing spring 150 may be a spring other than a pressing spring (compression spring), and the cover 140 may be biased by a biasing member other than a spring.

In the above-described embodiment, the heating tool and the heat-pressing machine according to the present invention have been mainly described. However, the above-described embodiment is merely an example for facilitating understanding of the present invention, and is not intended to limit the present invention. The present invention can be modified or improved without departing from the spirit of the invention, and the present invention naturally includes equivalents thereof.

### REFERENCE SIGNS LIST

H: heat-pressing machine
1: heat-pressing body
10: base member
11: base body
12: placement plate
13: placement mat
14: support shaft
15: rotating shaft
16: storage recess
16a: removal recess
16b: hook portion
17: cable storage recess
17a: hook portion
20: rotating member
30: pressing member
31: pressing body
32: heater unit
40: handle
45: handle shaft
50: locking device
54: operation member
60: user operation unit
65: lamp
70: controller
80: power cord
90: electric cable
100: heating tool
110: housing
111: cap fitting portion
112: grip hook portion
113: substrate
114: metal rod
115: second substrate
116: holding member
116a: main body portion
116b: flange portion
117: gap
120: cap
121: housing fitting portion
122: switch attachment portion
122a: opening
123: lamp attachment portion
123a: opening
130: grip member
131: housing hook portion
132: protrusion
140: cover
141: cover upper wall portion
141a: through-hole
142: cover inner wall portion
143: cover bottom wall portion
144: cover outer wall portion
150: biasing spring (biasing member)
160: heating member
161: shaft portion
162: first heating portion
163: second heating portion
170: cable connection portion
180: operation switch
185: lamp
M: transfer object (clothing)
S: thermal transfer sheet

What is claimed is:

1. A heating tool for heating a heating object while being pressed against a surface thereof, comprising:
a housing which serves as a main body of the heating tool;
a cover which is provided at a tip of the housing and moves forward and backward relative to the housing to be switched between a normal position and a retracted position in which the cover is retracted from the normal position toward the housing;
a biasing member that is attached to the cover and biases the cover toward the normal position; and
a heating member that is provided inside the cover and is exposed from an opening at a tip of the cover in accordance with the forward and backward movement of the cover,
wherein the heating tool presses the tip of the cover against the surface of the heating object so that the cover is retracted to the retracted position and the heating member is brought into contact with the surface of the heating object through an opening of the cover.

2. The heating tool according to claim 1,
wherein the cover is a heat-resistant hollow cover, is provided to surround the heating member, and is not in contact with a portion that contacts the heating object in the heating member, and
wherein when the cover is retracted to the retracted position, the heating member is formed so that a contact surface of the heating member is flush with a tip surface of the cover and or formed to protrude further than the tip of the cover.

3. The heating tool according to claim 2,
wherein the biasing member connects the housing to the cover, is provided at a plurality of positions to sandwich the heating member therebetween, and biases the cover from the retracted position toward the normal position, and
wherein the cover is disposed to be interposed between the heating member and the biasing member.

4. The heating tool according to claim 1,
wherein the cover includes a cover inner wall portion which extends in a forward and backward movement direction of the cover and is interposed between the heating member and the biasing member, a cover bottom wall portion which protrudes outward in a width direction of the heating tool from a tip of the cover inner wall portion and is disposed at a position facing a tip of the biasing member, and a cover outer wall portion which extends toward the opposite side to the biasing member in the forward and backward movement direction of the cover from an extension end of the cover bottom wall portion and is disposed to surround a tip of the heating member, and
wherein the tip of the biasing member protrudes toward the tip of the cover further than a base end of the heating member in the forward and backward movement direction of the cover and does not protrude further than the tip of the heating member.

5. The heating tool according to claim 1, further comprising:
a grip member that is fixed to the tip of the housing, is disposed to cover the cover from the outside, and is held by a user,
wherein the grip member is disposed to surround the cover, the heating member, and the biasing member from the outside and is disposed at the same height position as the cover, the heating member, and the biasing member in a forward and backward movement direction of the cover, and
wherein an outer surface of the grip member is provided with a plurality of protrusions which are arranged on the outer surface of the grip member at intervals and respectively extend in the forward and backward movement direction of the cover.

6. The heating tool according to claim 1, further comprising:
a cable connection portion which is provided in the housing or a cap attached to a base end of the housing and is connected to an electric cable for supplying electricity;
an operation switch which is provided in the housing or the cap and supplies electricity to the heating member or stops the supply of electricity; and
a lamp which is provided in the housing or the cap and lights up when electricity is supplied to the heating member,
wherein the operation switch is disposed on the opposite side to the cable connection portion in an outer peripheral surface or an outer surface of the heating tool, and
wherein the lamp is disposed on the opposite side to the cable connection portion and on the side of the operation switch in the outer peripheral surface or the outer surface of the heating tool.

7. A heat-pressing machine with the heating tool according to claim 1, comprising:
a heat-pressing body which serves as a main body of the heat-pressing machine,
wherein the heating tool is used after a thermal transfer process by the heat-pressing body,
wherein a bottom surface of the heat-pressing body is provided with a storage recess for storing the heating tool,
wherein the heating tool is storable in the storage recess in a state of the normal position in which the heating member is stored inside the heating tool and is removable from the storage recess in the state of the normal position, and
wherein the heating tool is stored in the storage recess not to protrude from the storage recess.
